(19) United States
(12) Patent Application Publication
(10) Pub. No.: US 2012/0088055 A1
(43) Pub. Date: Apr. 12, 2012

(54) WEAR PLATE

(75) Inventor: Brian Davies, Western Australia (AU)

(73) Assignee: BRIAN INVESTMENTS PTY LTD, Esperance, Western Australia (AU)

(21) Appl. No.: 13/255,316

(22) PCT Filed: Mar. 9, 2010
(86) PCT No.: PCT/AU2010/000269

§ 371 Date: Dec. 23, 2011

(30) Foreign Application Priority Data
Mar. 9, 2009 (AU) 2009901009

(51) Int. Cl. B65G 11/16; G06F 17/50; B23P 17/00; B32B 3/24; B32B 33/00

(52) U.S. Cl. 428/44; 428/131; 428/80; 29/525.01; 703/1

(57) ABSTRACT

A wear plate system comprises whole hexagonal plates configured to tessellate with each other, part plates which are derived from respective whole plates, and second triangular plates. The plates are provided with holes to receive fasteners for securing the plates to a structure. The holes are located in the plates in a configuration such that when the plates are tessellated to form a substantially continuous lining, the holes form a repeating pattern. The second plates are configured to facilitate the formation of straight edges on the lining to match an edge of a structure to which the lining is attached.

### FIELD OF THE INVENTION

The present invention relates to wear plates and applications thereof in the construction or protection of materials handling structure and equipment.

### BACKGROUND OF THE INVENTION

Structures and equipment (hereinafter referred to collectively and severally as “structures”) through which abrasive materials travel or pass are subject to wear. It is known to install wear plates in such structures to protect them from wear. In this event, the wear plates form or act as a sacrificial surface and wear instead of the underlying structure.

Current wear plates are designed to suit the structure that they are installed in, such as hoppers, chutes etc. Such structures are usually one off custom build units or have limited production runs (eg, two or three units) and accordingly not made to uniform or standard shapes or dimensions. Consequently, associate wear plates are usually customised for the particular structure. This means that each wear plate is individually designed and manufactured. This leads to the need to carry a large inventory of wear plates of each specific design to facilitate quick replacement of worn plates. If the replacement plates are not held in inventory they will require custom manufacture.

### SUMMARY OF THE INVENTION

According to an aspect of the present invention there is a wear plate configured in the shape of a polygon, capable of tessellating in a first pattern with other wear plates of the same shape; and, provided with at least one hole for receiving a fastener for securing the wear plate to a structure, the at least one hole positioned to form a second pattern with other holes of the other wear plates when the other wear plates are arranged in the first pattern, where the first pattern is different to the second pattern.

In an embodiment the wear plate has a first number of sides and the wear plate is provided with a second number of holes, where the number of sides is greater than the number of holes.

The number of sides may be six and the number of holes may be four. In one form of this embodiment the shape is a regular hexagon.

The holes may be positioned equidistant from respective closest corners of the wear plates. Two of the holes may be aligned with a line running parallel to one side of the wear plate. When the polygon shape is a regular hexagon and the number of holes is four, the holes may be located at corners of an imaginary rectilinear figure configured with two opposite sides parallel to respective adjacent sides of the wear plate and two remaining sides aligned with respective corners of the wear plate closest to the holes. The rectilinear figure may be a rectangle or a square.

In an alternated embodiment the wear plate may be of a shape which remains when a hexagon is bisected and one of the bisected portions is removed (hereinafter referred to as a “half-hexagon”) and may be provided with two holes. In one form of this embodiment the half-hexagon is a regular trapezium and the number of holes is two. In an alternate form of this embodiment the half-hexagon is an irregular pentagon.

The polygon shape may be a rhombus and the number of holes may be two. The rhombus may be formed with two corners having an included angle of 60 degrees.

The polygon shape may be an equilateral triangle and the number of holes may be one or two.

In an embodiment the holes are symmetrically placed equidistant from two opposite sides/corners of the wear plate.

The first pattern may be a pattern of tessellating triangles, rhombuses or hexagons.

The second pattern may comprise a repeating pattern of rectangles of uniform configuration or a repeating pattern of two rectangles of different configuration. In one embodiment the rectangles of different configuration comprise a first rectangle of a first width and a second rectangle of a second width twice the first width. In an embodiment the rectangles have the same height. In an embodiment the height is about 0.866% of the width of the wide rectangle.

In another aspect the invention provides a wear plate system comprising:
a set of first wear plates comprising:
a plurality of whole wear plates, each whole wear plate being in accordance with the first aspect of the invention; and,
one or more part plates wherein each part plate is derived from a whole plate and has at least one side that incorporates at least a portion of a side of a whole plate and at least one of the holes of that whole plate;
the holes in the first wear plates positioned to generate a repeating second pattern when the first wear plates are tessellated in the first pattern.

The wear plate system may comprise a set of one or more second plates, the or each second wear plate being of a different shape to, and having maximum dimension in a plane of the second wear plate greater than a maximum dimension in a plane of, a whole wear plate; the or each second wear plate configured to abut along the sides of two or more first plates when tessellated in the first pattern to form a substantially continuous wear plate liner surface, the second wear plates provided with one or more holes through which respective fasteners can pass and engage the second plates; the holes in the first wear plates and the holes in the second wear plates positioned to lie in the repeating second pattern.

In a further aspect the invention provides a wear plate system comprising:
a set of first wear plates and a set of one or more second wear plates;
the set of first wear plates comprising:
a plurality of whole wear plates of a uniform shape and dimension and configured to enable the plates to tessellate on a first pattern, each whole plate provided with a plurality of holes through which respective fasteners can pass and engage with the wear plate; and,
one or more part plates wherein each part plate is derived from a whole plate and has at least one side that incorporates at least a portion of a side of a whole plate and at least one of the holes of that whole plate;
the or each second wear plates being of a different shape and having maximum dimension in a plane of the second wear plate greater than a maximum dimension in a plane of a first wear plate, the or each second wear plates configured to abut along the sides of two or more first plates when tessellated in the first pattern, the second wear plates provided with one or more holes through which respective fasteners can pass and engage the second plates;
the holes in the first wear plates and the holes in the second wear plates positioned to generate a repeating second pattern when the first wear plates are tessellated in the first pattern, and the second plates abut sides of two or more first wear plates to form a substantially continuous wear plate liner surface.

In this aspect, the whole plates may have the shape of a hexagon and the respective second plates may have the shape of a triangle. The set of second plates may comprise wear plates of different dimensions.

In an embodiment a part plate may have any one of the following shapes or configuration:
a half-hexagon;
a third of a hexagon;
a quarter of a hexagon;
a sixth of a hexagon;
5/12 of a hexagon;
1/12 of a hexagon;
7/12 of a hexagon;
⅔ of a hexagon;
¾ of a hexagon;
⅚ of a hexagon;
a rhombus;
a regular trapezium;
a pentagon;
a quadrilateral;
a triangle;
an irregular hexagon.

In one embodiment each whole wear plate has at one side of a length scaled to one unit, and the each part plate has at least one side of a length of one unit.

In one embodiment the holes are arranged in first parallel lines extending in a first direction, where the first parallel lines are sequentially spaced first and second distances apart. In this embodiment the holes are further arranged in second parallel lines that extend orthogonal to the first parallel lines. Mutually adjacent second parallel lines may be uniformly spaced a third distance from each other.

In one embodiment the first distance apart is one unit. The second distance apart may be 0.5 units. The third distance apart may be about 0.866 units

In a further aspect the invention provides a method of constructing a materials handling structure through which abrasive materials pass, the structure having one or more sides to which a plurality of wear plates is to be attached, the method comprising:
forming a plurality of wear plates comprising one or more whole plates and one or more part plates, each whole plate being provided with a plurality of holes through which respective fasteners can pass, each whole plate having a uniform shape and dimension and configured to enable the plates to tessellate in a first pattern, wherein one or more of the part plates is cut from a whole plate wherein each part plate includes at least one side that incorporates a portion of a side of a whole plate and at least one of the holes of a whole plate;
dimensioning the or each side of the structure to have a length and a height sufficient to accommodate at least one of the whole plates;
forming the or each side of the structure with a plurality of holes for receiving fasteners at locations that register with holes in the whole plates and the part plates when the whole plates and part plates are arranged in the first pattern; and
covering the or each side with the whole plates and part plates arranged in the first pattern to form a substantially continuous wear plate lining and fastening the plates to the side by fasteners that pass through holes in the plates and the holes in the side of the structure.

The plates may be arranged so that edges of mutually abutting vertically adjacent whole plates are vertically offset.

The method may comprise securing strengthening elements to the structure on a side opposite that covered by the plates, wherein the strengthening elements extend along locations that do not cover the holes in the side of the structure.

The method may comprise forming each whole plate to have a plurality of sides of equal length A, and dimensioning the or each side of the structure may comprise dimensioning the length and height of the or each side to be a multiple of (√0.75/2)A in length or height, and 0.5 A in the other of length or height.

In yet another aspect the invention provides a method covering a side of a structure with a plurality of wear plates, the method comprising:
providing a plurality of whole wear plates wherein the whole wear plates are of uniform shape and dimension and configured to enable tessellation in a first pattern, the wear plates dimensioned so that at least one whole plate can fit on the side, the whole plates being provided with a plurality of holes through which respective fasteners can pass to fix the wear plates to the structure, the holes being arranged in a second pattern;
determining an area between an outer edge of the whole plates when tessellated on the side to form a partial wear plate lining and adjacent edges of the side of the structure being covered with wear plates:
cutting one or more part plates from one or more of the whole plates capable of at least partially covering the area when tessellated with the whole plates, wherein each part plate is cut with at least one side incorporating a portion of the side of the whole plate and at least one of the holes of the whole plate; and
covering the side of the structure with the whole plates and part plates to produce a substantially continuous wear plate lining of whole and part plates tessellated in the first pattern; and,
attaching the plates to the surface with mechanical fasteners.

The method further comprises providing a plurality of triangular plates each having a maximum dimension greater than a maximum dimension of a whole plate, wherein the triangular plates are configured to cover one or more areas of the surface not covered by whole plates and/or part plates.

According to an aspect of the present invention there is a method of design of a structure subject to wear comprising providing fastening means arranged in parallel lines, where two lines are closer together than other adjacent lines in one direction and the lines are equidistant in another direction.

In an embodiment the at least a first pair of lines of holes are one scaled dimension unit apart. In an embodiment the at least a second pair of lines of holes parallel to the first pair are 0.5 scaled dimension units apart.

In an embodiment the at least a third pair of lines of holes are about 0.866 units apart. In an embodiment the third pair of lines of holes is perpendicular to the first pair of lines of holes

According to an aspect of the present invention there is a computer system arranged to design a structure subject to wear comprising:
an input device which receives user input;
means of interpreting the input so as to conform with or only allowing input which conforms with one of the method defined above.

According to an aspect of the present invention there is a computer program embodied on a computer readable medium comprising instructions for controlling a processor of a computer to operate the computer as the above computer system.

### BRIEF DESCRIPTION OF THE DRAWINGS

In order to provide a better understanding, embodiments of the present invention will now be described in greater detail, by way of example only, with reference to the accompanying drawings, in which:

FIG. 1 is a plan view of a lining or cover formed from a plurality of wear plates according to a first embodiment of the present invention;

FIG. 2 is a plan view of a lining or cover formed from a plurality of wear plates according to a second embodiment of the present invention;

FIG. 3 is a plan view of a wear plate according to the first embodiment of the present invention;

FIG. 4 is a plan view of a plurality of the wear plates of FIG. 3 arranged in a repeating pattern;

FIG. 5A is a plan view of the wear plate shown in FIG. 3;

FIG. 5B is a plan view of a wear plate derived from the wear plate shown in FIG. 5A;

FIG. 5C is a plan view of another wear plate derived from the wear plate shown in FIG. 5A;

FIG. 5D is a plan view of another wear plate derived from the wear plate shown in FIG. 5A;

FIG. 5E is a plan view of another wear plate derived from the wear plate shown in FIG. 5A;

FIG. 5F is a plan view of another wear plate derived from the wear plate shown in FIG. 5A;

FIG. 5G is a plan view of another wear plate derived from the wear plate shown in FIG. 5A;

FIG. 5H is a plan view of a further wear plate derived from the wear plate shown in FIG. 5A;

FIG. 5I is a plan view of a further wear plate derived from the wear plate shown in FIG. 5A;

FIG. 5J is a plan view of a further wear plate derived from the wear plate shown in FIG. 5A;

FIG. 5K is a plan view of a further wear plate derived from the wear plate shown in FIG. 5A;

FIG. 5L is a plan view of a further wear plate derived from the wear plate shown in FIG. 5A;

FIG. 5M is a plan view of yet another wear plate derived from the wear plate shown in FIG. 5A;

FIG. 5N is a plan view of yet another wear plate derived from the wear plate shown in FIG. 5A;

FIG. 5O is a plan view of yet another wear plate derived from the wear plate shown in FIG. 5A;

FIG. 5P is a plan view of yet another wear plate derived from the wear plate shown in FIG. 5A;

FIG. 5Q is a plan view of yet another wear plate derived from the wear plate shown in FIG. 5A;

FIG. 5R is a plan view of yet another wear plate derived from the wear plate shown in FIG. 5A;

FIG. 5S is a plan view of yet another wear plate derived from the wear plate shown in FIG. 5A;

FIG. 6A is a plan view of a wear plate according to a third embodiment of the present invention;

FIG. 6B is a plan view of a wear plate derived from the wear plate shown in FIG. 6A;

FIG. 6C is a plan view of another wear plate derived from the wear plate shown in FIG. 6A;

FIG. 6D is a plan view of another wear plate derived from the wear plate shown in FIG. 6A;

FIG. 6E is a plan view of another wear plate derived from the wear plate shown in FIG. 6A;

FIG. 6F is a plan view of another wear plate derived from the wear plate shown in FIG. 6A;

FIG. 6G is a plan view of another wear plate derived from the wear plate shown in FIG. 6A;

FIG. 7 is a side elevation of a lining composed of a plurality of wear plates according to the present invention configured for installation in a belt feed-on chute;

FIG. 8 is a side section view of a lining composed of wear plates according to the present invention installed in a stockpile apron feeder discharge chute;

FIG. 9 is an end view of the another lining of wear plates installed in the chute of FIG. 8;

FIG. 10 is an upper isometric view of the chute of FIG. 8;

FIG. 11 is a lower isometric view of the chute of FIG. 8;

FIG. 12 is a side elevation of structure fitted with a modular wear plate system according to an embodiment of the present invention; and,

FIG. 13 is a template showing the configuration of possible second or boundary plates that are incorporated in a further embodiment of the present invention.

### DETAILED DESCRIPTION OF EMBODIMENTS OF THE PRESENT INVENTION

Wear plates in accordance with embodiments of the present invention are in the shape of a polygon capable of tessellating in a first pattern and provided with at least one hole for receiving a fastener for securing the wear plate to a structure. The holes are positioned in the plates so that when the wear plates are tessellated in the first pattern the holes form a second pattern with holes of the tessellated wear plates where the second pattern is different from the first pattern. This enables the formation of a wear liner composed of a plurality of the wear plates with the holes arranged in a known pattern or configuration. Accordingly the structure to which the lining is to be applied may be pre-formed with holes in the same pattern. These wear plates may be considered as whole or key plates. Embodiments of the invention provide for the formation of part plates which are derived from the whole or key plates and are configured to abut edges of adjacent whole or key plates to maintain continuity of the lining. The part plates are derived typically by cutting of the whole plates and are moreover cut so that the part plates are provided with one or more of the holes of the whole plates. This enables a continuation of the second pattern of holes when the part plates are utilised in the lining.

As described in greater detail below, in one embodiment a wear plate system is provided to form a continuous lining where the wear plate system comprises a first set of plates which comprise whole plates or part plates derived from the whole plates, and a set of second plates which have a different shape and have a greater maximum dimension than the first set of plates but are also able to abut with the first plates to form a continuous liner. Specifically, the whole plates take the form of hexagonal plates while the second plates are in the form of triangular plates. Thus to line a structure, an inventory of only hexagonal plates and triangular plates are required. The part plates may be formed by cutting one or more of the whole plates.

There is also described in greater detail below, embodiments of the invention to enable the construction of materials handling structures such as chutes in a manner where the chute has sides dimensioned based on the size of the whole plates and can be pre-formed with holes in the second pattern and thus registering with the holes in the wear plates. This also has the benefit of enabling the attachment of strengthening beams to the outside of the structure at locations that do not overlie the holes and thus interfere with the fastening of the wear plates to the structure.

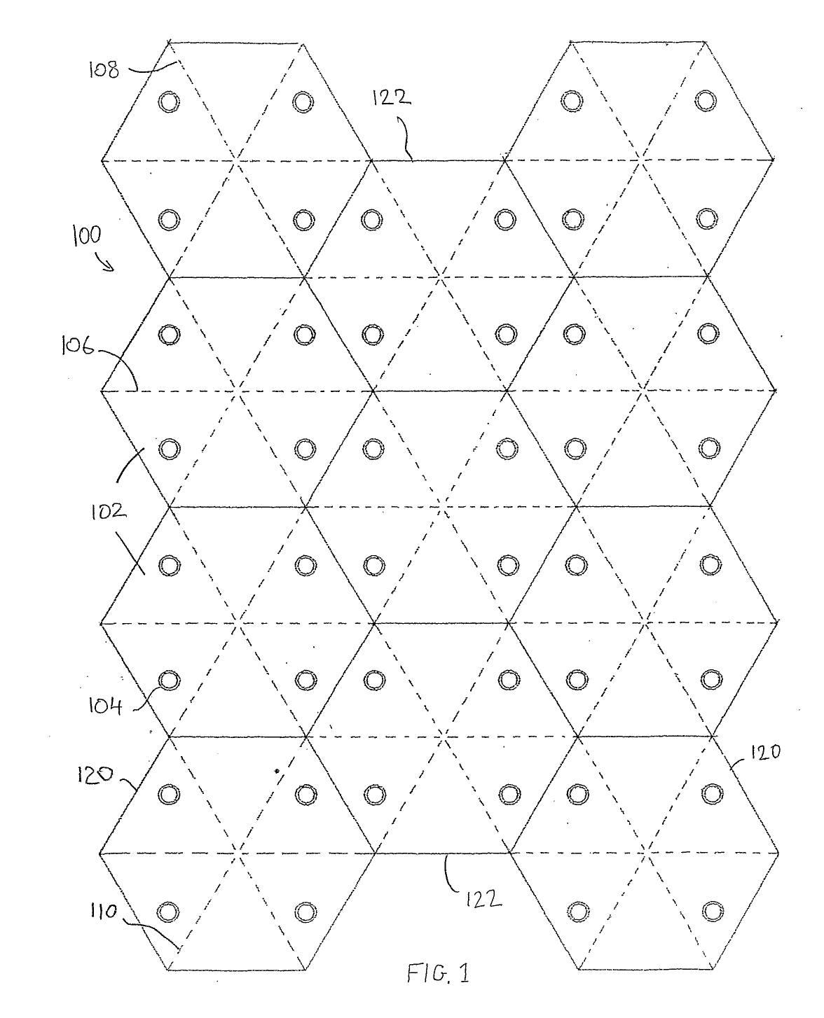

Referring to FIG. 1 is shown a lining or cover 100 composed of a plurality of whole wear plates 102. The wear plates 102 are regular hexagonal in shape and tessellate in a first pattern to form the continuous lining 100. Each wear plate 102 has four holes 104 which enable the wear plate 102 to be fixed to a structure. Due to the hexagonal shape of the wear plates 102, each side is aligned with one of a plurality of parallel lines 106, 108 or 110. The lines 106 extend horizontally across the page. The lines 108 extend at 60 degrees (clockwise) from the lines 106 and the lines 110 extend at 60 degrees (anticlockwise) from the lines 106. It can also be seen that the holes 104 are in or form a second pattern.

In an embodiment the holes 104 are conical in shape so as to receive a fastener, such as a bolt with a conical head of the type described in WO 2006/060877. This enables the fasteners to also engage with the wear plates 102. The thickness of the wear plates can be as required for the particular application and the harness and material of the wear plate made be as required for the particular application. For example the plates may be 100 mm thick, of hardened steel, with a Brinnell hardness of at least 300 BH and preferably at least 600 BH. Other materials can be used such as rubber or ceramics.

The lining 100 is shown with two generally vertically extending edges 120 and two generally vertical edges 122 with respect to the page. Each edge is comprised of corrugations due to the shape of the hexagons. The edges 120 have triangular or saw tooth shaped corrugations and the edges 122 have flattened sine wave-like corrugations.

The lining 100 having such corrugated edges will not completely cover a surface requiring wear protection where that surface has straight edges. Accordingly, as explained later below, part or edge plates derived from the whole plate 102 may be provided to fit in the corrugations and thus enable the lining 100 to completely cover the surface.

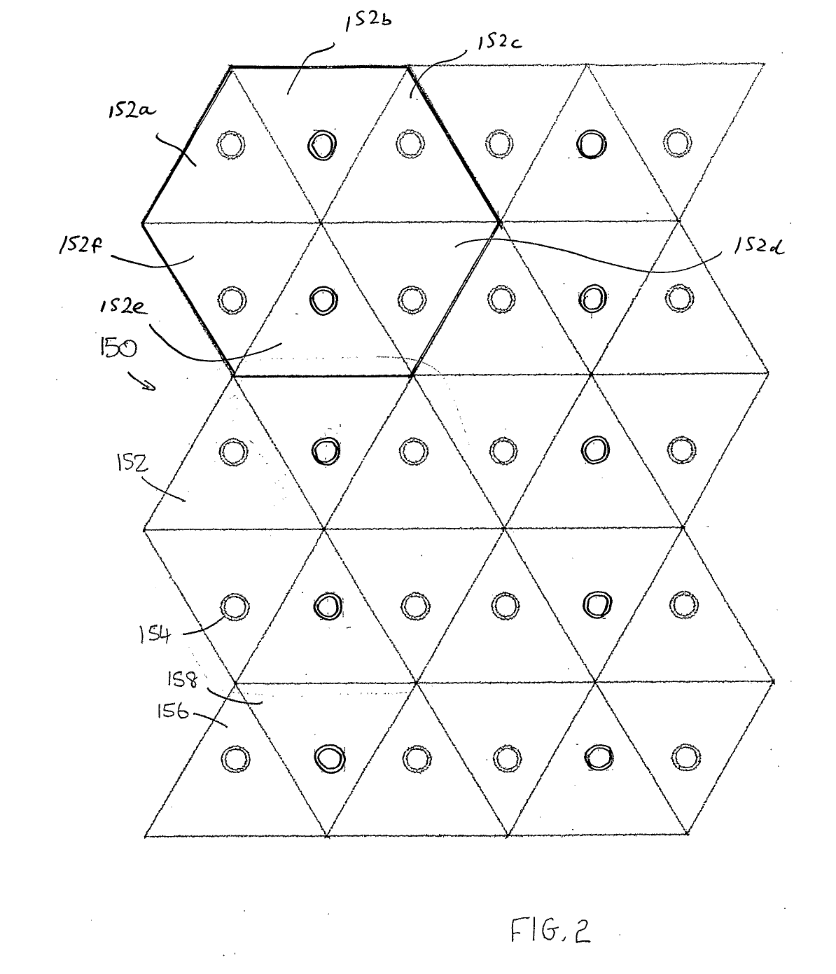

Referring to FIG. 2, a lining 150 of whole wear plates 152 of a different shape and configuration to the plates 102 is shown. Each of the wear plates 152 has the shape of an equilateral triangle thus enabling tessellation to form the continuous lining 150. Each wear plate 152 has a hole 154 which enables the wear plate 152 to be fixed to a structure. Due to the triangular shape of the wear plates 152 it can be seen that a group of six of the triangle plates can be arranged to form a hexagonal shape in the lining 150. For example, plates 152a, 152b, 152c, 152d, 152e and 152f form a hexagonal shape.

The lining 100 has a lower density of holes than the holes of lining 150. In both cases the holes are arranged in a repeating rectangular pattern. In the lining 100 there is no equivalent line of holes to every third line (across the page) in lining 150. Thus fewer fasteners are required when using in lining 100 to cover the same area assuming the area of each plate 102 is the same as the area of the hexagonal shape made by six tessellating plates 152.

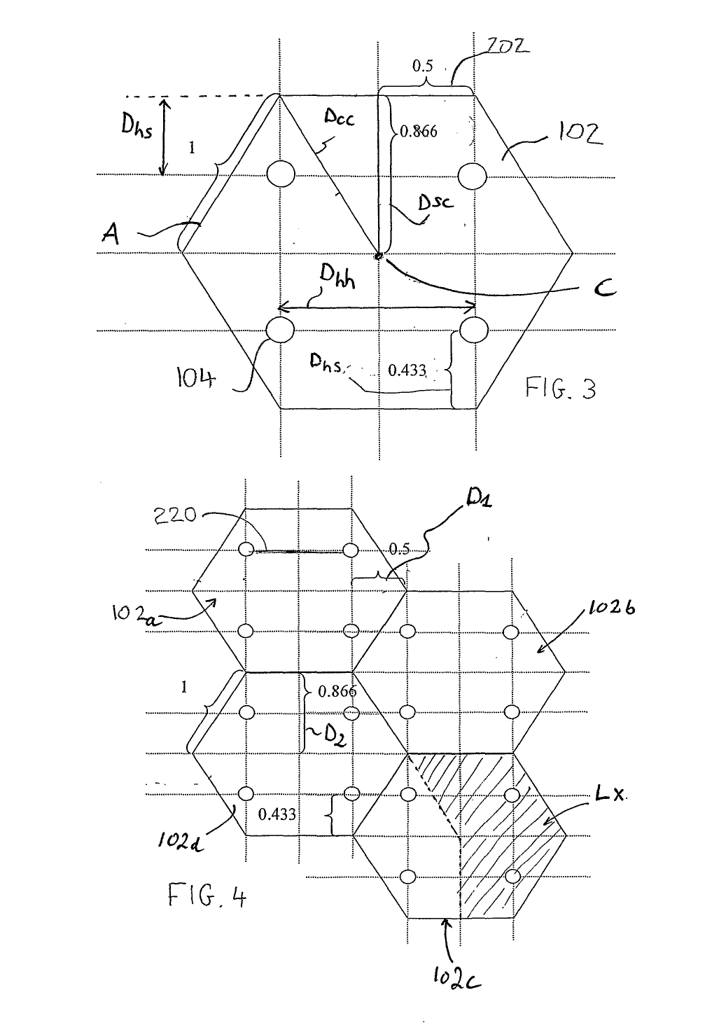

FIGS. 3 and 4 show the positions of the holes in the lining 100 in FIG. 1. The wear plates 102 in lining 100 are oriented so at the have two opposite sides horizontal on the page. Each side S1 to S6 of each wear plate 102 has a length of one unit. The distance Dcc from the geometric centre C of each plate 102 to any corner is also one unit. The horizontal distance Dₕₕ between adjacent hole centres is one unit, each one being 0.5 units from a vertical line through the centre C. Thus the holes on either side are in line with the respective side corners which coincide with the horizontal sides and one unit apart. The horizontal sides are vertically spaced a distance D_{sc} of about 0.866 (the square root of 0.75) units from a horizontal line through the centre C. The (centre of the) lower holes are one half of the distance between the bottom size and the horizontal line through the centre. That is the bottom holes are spaced a distance Dₕₛ of about 0.433 units (i.e. (√0.75)/2) from the bottom side. The top holes are also spaced a distance Dₕₛ of about 0.433 units from the top side. The top and bottom holes are therefore 0.833 units apart.

FIG. 4 shows four tessellated wear plates 102a, 102b, 102c and 102d. The nearest holes in the “horizontally adjacent” wear plate 102a and 102b are a distance D1 of 0.5 units apart. The nearest holes in vertically adjacent wear plates 102a and 102c are spaced a distance D2 of about 0.866 units apart.

The holes can be seen to lie on equally spaced imaginary horizontal lines. The holes also lie on a repeating pattern of imaginary vertical lines of 1 and then 0.5 units apart.

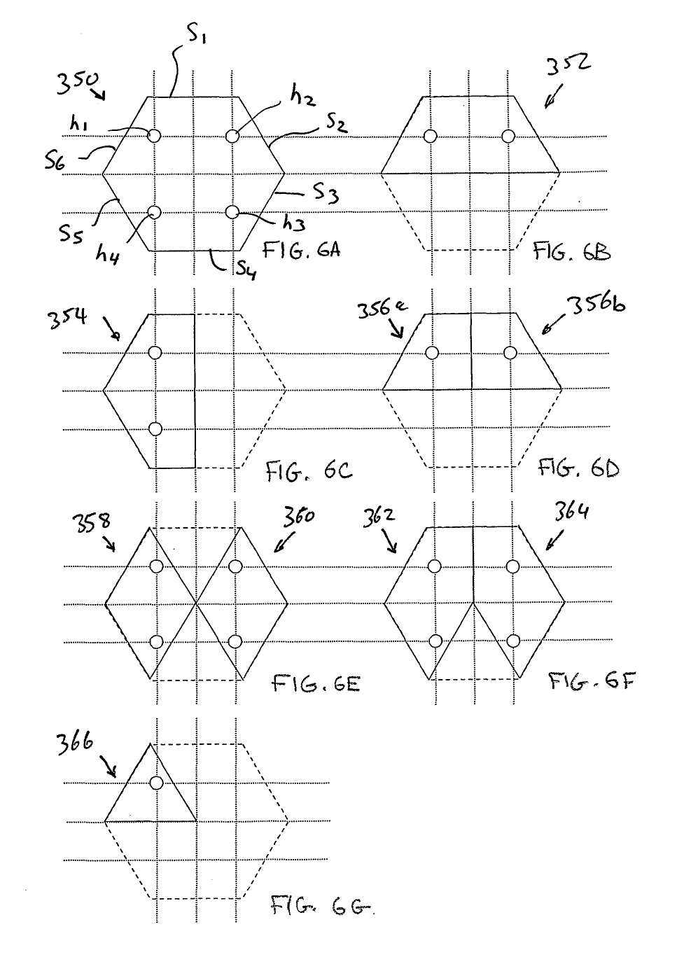

In another embodiment the position of the holes lie on a checkerboard like pattern of lines where adjacent horizontal lines and adjacent vertical lines are 0.866 units apart. This spacing is used in the embodiment described below in FIG. 6A to 6G. Other hole patterns are possible.

When an area of a structure is to be covered with a lining of wear plates, a significant portion of the area can be made of the repeating pattern of key or whole wear plates (such as the hexagonal wear plates) of an appropriate size. For example the whole plates may be formed with a side length (one scaled unit) of 100 mm; or 200 mm; or 400 mm. Other sizes are possible.

In the following embodiment the hexagon shaped wear plate is the key or whole wear plate. However in other embodiments wear plates of other shape may be used for the key or whole wear plate such as the triangle of FIG. 2 and a rhombus with two of the opposite corners being 60 degrees.

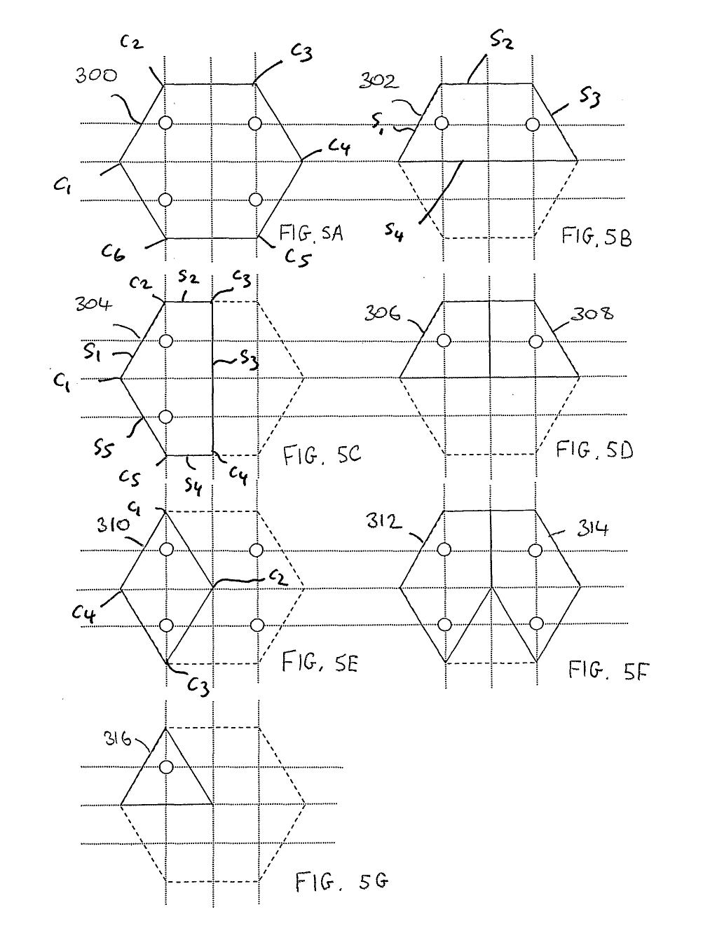

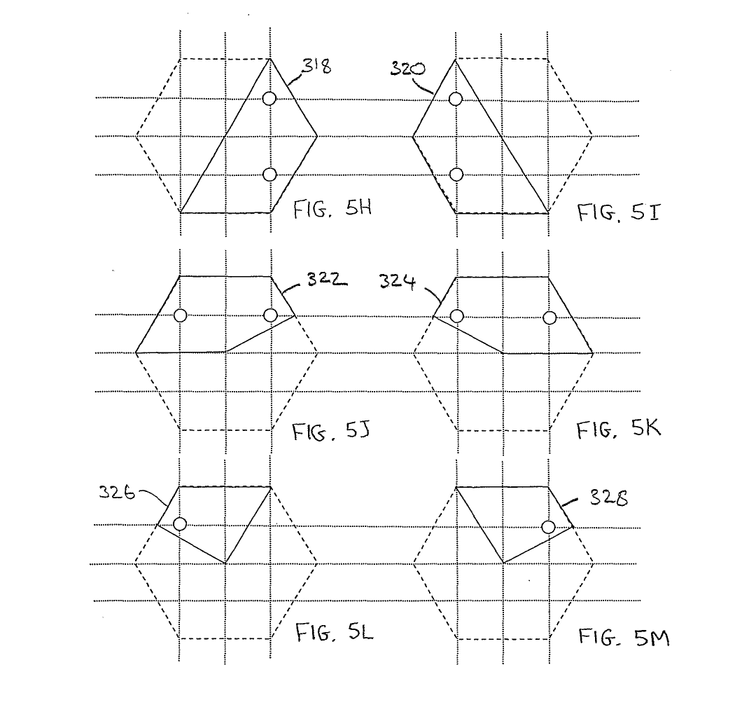

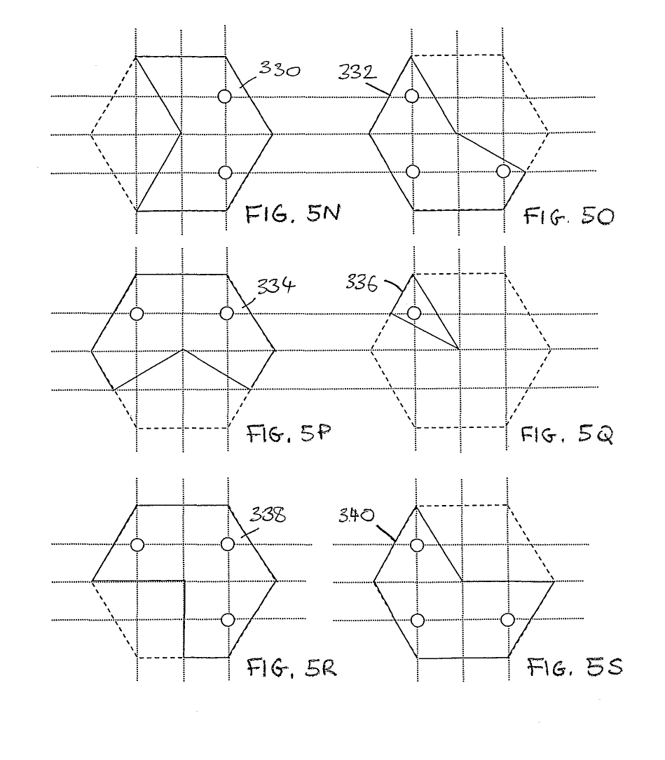

In the present embodiment of interest, the whole or key wear plate 300 is of hexagonal shape and shown FIG. 5A. To form a lining 100 having a straight rather than corrugate edge wear plates of other shapes are derived from the whole hexagonal wear plate 300.

FIG. 5B shows a part or edge plate 302 formed by cutting a whole plate 300 in half from corner to corner to have a shape of a regular trapezoid with sides S1, S2, S3 and S4 of a length of 1, 1, 1, and 2 units respectively. The included angle of corners C1-C4 is 60 degrees, 120 degrees, 120 degrees and 60 degrees, respectively. The holes are symmetrically positioned.

FIG. 5C shows a part or edge wear plate 304 also formed by cutting a whole plate 300 in half but along a different line to form a shape of an irregular pentagon. The plate 304 has sides S1-S5 of length 1, 0.5, about 1.732, 0.5 and 1 units respectively. The included angle of each corner C1-C5 is 120 degrees, 120 degrees, 90 degrees, 90 degrees and 120 degrees, respectively. The holes are symmetrically positioned.

FIG. 5D shows two part plates 306 and 308 each of a “quarter-hexagon” shape, one with a “left handed point” one with a “right handed point”. These are formed by cutting the wear plate 300 firstly in half to form the plate 302 then cutting the plate 302 in half symmetrically between the holes.

FIG. 5E shows a part or edge plate 310 derived from whole plate 300. Plate 310 is in the shape of a rhombus with the length of the sides being 1 unit and the included angles of the corners C1, C2, C3 and C4 being 60 degrees, 120 degrees, 60 degrees and 120 degrees, respectively. The holes are symmetrically placed.

FIG. 5F shows two part or edge plates 312 and 314 each being 5/12ths of the whole wear plate 300, one “left-handed” and one “right-handed”. One of the corners in each of plates 312 and 314 is a right angle.

FIG. 5G shows part edge plate 316 being a ⅙^{th} of the whole wear plate 300 and in the shape of an equilateral triangle. Each side of plate 316 is 1 unit in length. The hole is off-centre from the geometric centre of the plate 316.

The part wear plates of FIG. 5B to 5G may be considered to form a core set of part or edge wear plates which can be positioned as edging of lining 100 so that the lining 100 can be configured to have straight edges to enable complete coverage of surfaces of various configurations. Nevertheless this set of part wear plates might not be able to accommodate every desired overall shape. Additional part or edge plates 318 to 340 are shown in FIGS. 5H to 5S respectively, each derived from a whole plate 300. Some of these plates (e.g. 326, 328 and 336) may need to be rotated to fit the desired edge shape, but this can move the hole or holes for that shape out of pattern. This may be acceptable in some circumstances. Alternatively other ones of the part wear plates can be used which may mean that this is unnecessary, such as the part plates 318 to 324 shown in FIGS. 5H to 5K.

Some of the part or edge plates are related to other part plates such that two or more part plates of different shape together make a shape that can be replicated by a single part plate. For example the part wear plate 330 in FIG. 5N can be used in place of left and right handed rhombuses. The plate of FIG. 5R can be used in place of the left plate FIG. 5D and the plate of FIG. 5C. Other forms of part or edge plates may be evident to a skilled person.

FIG. 5H shows part or edge plate 318 in the configuration of a half-hexagon trapezoid wear plate with the hole positions asymmetrically left-handed.

FIG. 5I shows part plate 320 in the configuration of a half-hexagon trapezoid wear plate with the hole positions asymmetrically right-handed.

FIGS. 5J and 5K show part plates 322 and 324 which are each 5/12ths of the whole wear plate 300, one right handed one left handed. These do not have right angles (in contrast to those of FIG. 5F). FIGS. 5L and 5M show part plates 326 and 328 each of which is formed as a quarter portion of the whole wear plate 300, one with a “left handed point” one with a “right handed point”. These have different hole positions compared to those in FIG. 5D.

FIGS. 5N and 5P show part plates 330 and 334 each constitute ⅔s of a whole wear plate 300 but are of different configuration and have different hole positions.

FIG. 5O shows part plate 332 which constitutes 7/12ths of a whole wear plate 330.

FIG. 5Q shows part plate 336 which constitutes a 1/12^{th} of wear plate and has the shape of a right angle triangle.

FIG. 5R shows part plate 338 which constitutes a ¾ of wear plate 300.

FIG. 5S shows part plate 340 which is formed by cutting a parallelogram section from a plate 300.

FIG. 6A is a plan view of an alternative key or whole wear plate 350 which is also of a hexagonal shape but having holes h1-h4 in a pattern of a square. The distance of upper holes h1 and h2 from the top side S1 is a quarter of the distance between the top side S1 and the bottom side S4. The left holes h1 and h4 are spaced from the right holes h2 and h3 by a distance one half of the distance between the top side S1 and the bottom side S4. Each hole is equidistance from a respective closest corner.

Various part plates 352 to 366 can be derived from the key or whole wear plate 350 as shown for example in FIGS. 6B to 6G.

FIG. 6B shows part plate 352 in the shape of a regular trapezoid.

FIG. 6C shows part plate 354 in the shape of a pentagon.

FIG. 6D shows part plates 356a and 356b each formed as a quarter cut from a whole plate 350, one with a “left handed point” 356a, and one with a “right handed point” 356b.

FIG. 6E shows part plates 358 and 360 each in the shape of a rhombus cut from and having a third of the area of a whole wear plate 350. The holes are asymmetrical.

FIG. 6F shows part plates 362 and 364 each cut in the shape of an irregular pentagon having an area of 5/12ths of a wear plate 350, part plate 362 being “left-handed” and part plate 364 being “right-handed”.

FIG. 6G shows a part plate 366 formed as a ⅙^{th} cut of wear plate 350, and in the shape of an equilateral triangle shaped. The hole is off-centre.

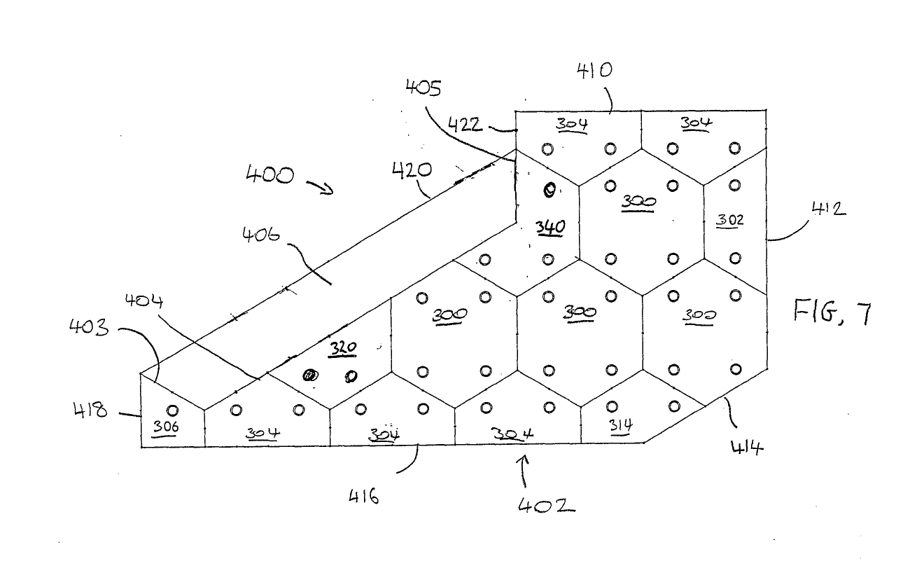

FIG. 7 shows a lining 402 formed from wear plates the lining 100 configured for installation in a belt feed-on chute 400. The chute 400 has sides 410, 412, 414, 416, 418, 420 and 422. A section 406 of the chute is not subject to wear, therefore the sheet 402 need not cover this section 406. Section is bound by side 420 and edges 403, 404 and 405.

The lining 402 comprises a repeating pattern of key wear plate 300, to the extent that the repeating pattern will fit within an area defined by the sides 410, 412, 414, 416, 418, edges 403, 404 and 405, and side 422. The gaps between the repeating pattern and the border of the area are filled with appropriate part or edge wear plates in order to complete the lining 402. The part plates comprise plates 304, 304, 302, 314, 304, 304, 304, 306, 320, 340 (clockwise from the top). At least one of the sides of these part wear plates contributes to the perimeter of the lining 402. At least one of the sides of two of the whole wear plates 300 also contribute to the perimeter. Further, the hole pattern of the lining 400 is uniform. In an alternate construction of the lining 400 the part plate 340 could be replaced with two part plates 310 and part wear plate 320 could be replaced with the part 302 plate, however this would distort the otherwise regular hole pattern. Nevertheless if this is not of concern this variation could be adopted.

The chute 400 has been designed with dimensions of the sides 410, 412, 414, 416, 418, edges 403, 404 and 405, and side 422 to be suitable multiples of the respective dimensions of the key or whole wear plate 300. When the plate 300 shown in FIG. 3 is rotated by ninety degrees it is orientated so that corners C1 and C4 lie on a vertical line (the “corner up” orientation). This is the orientation of the plates 300 when used in the chute 400 of FIG. 7. The plate in this orientation has a horizontal dimension of 1.732 units and vertical dimension of two units. With reference to FIG. 3 and maintaining the consideration of the corner up orientation, if we let 0.866 units be called “X” then the plate has a width or horizontal dimension of 2X. If we let 0.5 units be called “Y” then the plate has a height or vertical dimension of 4Y. In the chute 400 of FIG. 7 where the plates 300 are in the corner up orientation, side 410 is 4X long, side 412 is 7Y long, side 414 is 4Y long, side 416 is 8X long, side 418 is 2 Y long, edge 403 is 2 Y long, edge 404 is 10 Y long, edge 405 is 2 Y long and side 422 is 1 Y long. Clearly other structures can be designed with horizontal dimensions in multiples of X and vertical dimensions in multiples of Y, for corner up hexagonal key wear plates.

When the regular hexagonal wear plate 300 is orientated so that it has two opposite sides lying horizontally, for example as shown in FIGS. 3 and 5A, (hereinafter the “side up” orientation), then if we let 0.5 units be “X” and 0.866 units be “Y” the then plate 300 has a width or horizontal dimension of 4X (i.e. 2 units); and the a height or vertical dimension of 2Y (i.e. 1.732 units).

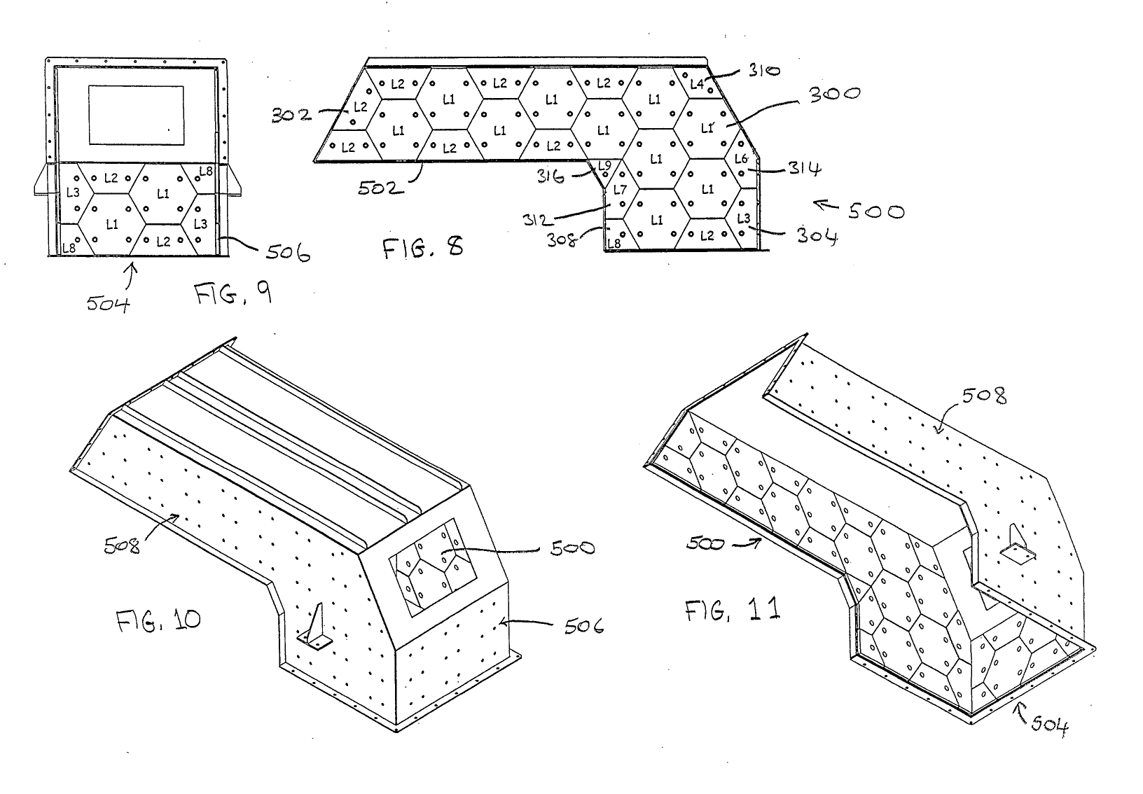

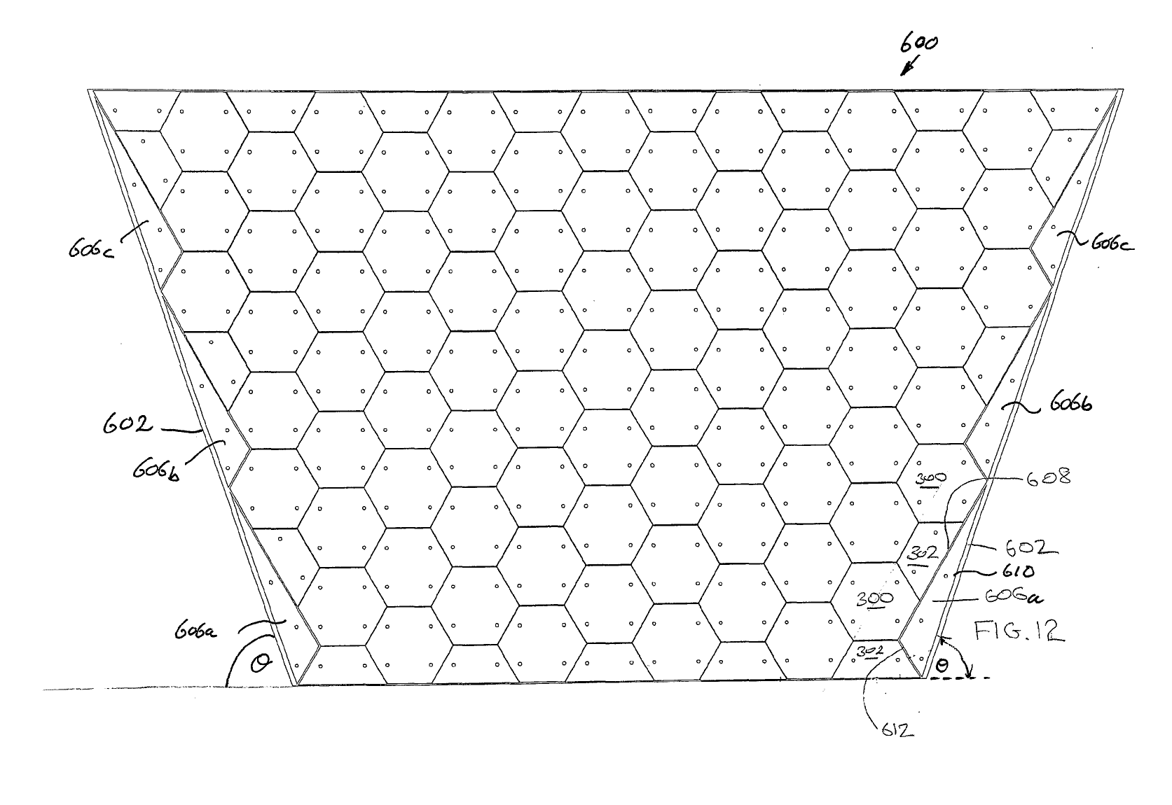

FIGS. 8 to 11 show an example of a structure fitted with wear plate linings 500 and 504. In FIG. 8 the area covered with the lining 500 is indicated as 502. In FIG. 9 the area covered with lining 504 is indicated as 506. In this example the structure is a stockpile apron feeder discharge chute. It can be seen that lining 500 comprises a repeating pattern of key wear plates 300 (labelled type L1) and part wear plate, comprising 310 (labelled L4), 314 (labelled L6), 304 (labelled L3), 308 (labelled L8), 312 (labelled L7), 318 (labelled L9) and 302 (labelled L2). Lining 504 comprises a repeating pattern of key wear plates L1 and part wear plates L2, L3, and L8.

It can be seen that the key hexagon wear plates 300 are oriented “side up” in this embodiment. The sides of the structure are designed with dimensions that are multiple of X and Y for the side up orientation.

FIGS. 10 and 11 show hole patterns 506 and 508, though walls of the structure so that a bolt can fasten the wear plates to the structure.

The positions of the holes in each hole pattern is designed to correspond with hole pattern in the corresponding lining. For side up orientation the holes lie on horizontal lines of Y (or 0.866) units apart and on vertical lines in a repeating pattern of X (or 0.5) units the 2X (or 1) unit apart. Not every hole need be in this pattern, for example the hole in L9 does not conform to the pattern, but its location can still be determined because the wear plate piece and the location of the hole(s) in it are known. However even here by appropriate use of the present wear plates and method the hole pattern can be maintained by replacing part plates L7 and L9 with another plate Lx which is cut from a whole plate 300 shown as shaded section of plate 102c in FIG. 4. Now the hole pattern is completely maintained.

For corner up hexagon key wear plate orientation, the holes lie on vertical lines X (0.866) units apart and on horizontal lines in a repeating pattern of Y (0.5) units apart then 2Y (1) unit apart. (X and Y swap unit values according to orientation).

A computer program can be used to assist in design of the structure to which the modular wear plate system of an embodiment of the present invention is to be applied. The computer program can be interface or be incorporated in a CAD program which assists (or forces) the designer to configure a structure to have sides or edges which are integer multiples of X and Y. For a given dimension of whole wear plate and hole configuration this will also automatically generate the position of holes required in the structure to register with the wear plates. Further as the position of the holes in the structure is known, the location of strengthening ribs can be prearranged to not overlie any of the holes and thus avoid interference with the fasteners which fasten the wear plates to the structure.

When the computer program is loaded and operated on a computer the computer is arranged to design a structure subject to wear by receiving input from a user via an input device (e.g. mouse or track ball). A processor of the computer will interpret the input so as to conform with the appropriate multiples of X and Y for dimensions of structures subject to wear. Alternatively the processor will only allow an input which conforms to this.

As shown by FIG. 1 having dimensions in multiples of the dimension of a whole wear plate does not produce straight edges. To produce the straight edges usually seen on industrial structures one more of the part or edge plates will be required. The computer program is capable of determining the part plates required to be cut from whole plates to provide straight edges as shown in the structures of FIGS. 7-11.

In some cases the angle of a side will not be 30 degrees, or 60 degrees. In this case a set of second or boundary plates of a different configuration to the whole plates and of a linear dimension in a plane of the plate greater than that of the whole plate is utilised. In this embodiment the second plates are of a triangular shape and have a maximum linear dimension greater the length of any line that can be drawn between any two points in a common plane on a whole plate. Such second plates can be configured to fill a gap between the edge of the structure and the remainder of the lining composed of the tessellated whole and part plates.

An example of this is shown in FIG. 12 which depicts a wall or side of a hopper bin 600 having side edges 602 which are inclined at an angle θ of about 71 degrees. Respective second wear plates 606a each of identical triangular configuration abut on edges 608 and 612 with whole plates 300 and part plates 302, while a long edge or side 610a of each plate 606a aligns with a respective edge 602 of the hopper bin 600. Further second triangular plates 606b and 606c of identical configuration to plates 606a are sequentially disposed end to end to complete the corresponding edge of the wear plate lining which runs in alignment with upwardly extending edges 602 of the bin 600.

Each of the plates 606a -606c (hereinafter “second plates 606”) has a side 608 of 4 units in length, side 610 of about 4.6 units in length and side 612 one unit in length. Indeed by use of the second or boundary plates it is possible to cover a wide range of structures with edges or boundaries of different angles with only the whole plates 300, the “half” part plates 302 and the triangular second plates.

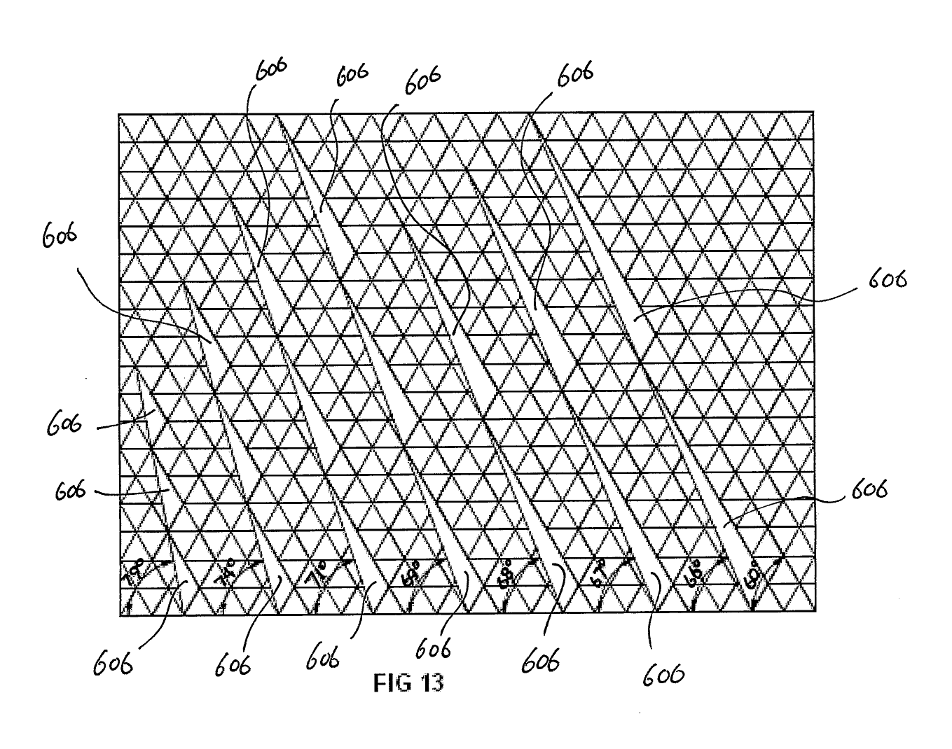

FIG. 13 shows for example a range of second triangular plates that can be used in conjunction with the whole and part plates 300 and 302 to form a continuous lining for a side of a structure similar to that shown in FIG. 12.

FIG. 13 shows that by designing a structure, e.g. a hopper bin, to have side wall with edges inclined at a range of angles θ=66, 67, 68, 69, 71, 74 and 79 degrees, the structure can be lined by wear plates of three basic shapes only, namely the whole plate 300, the “half” part plate 302, and a set of secondary or boundary triangular plates 606. The configuration of the triangular plates varies for different angles θ. In broad terms the length of side 612 always remains as 1 unit and the length of the shorter of the two remaining sides 608 will be an integral number of units. It will also be seen that the longest edge 610 of the triangular plate aligns with an edge of 602 of the structure and that the edges 610 of vertically adjacent triangular plates are in alignment.

Modification and variation as would be obvious to a skilled person are intended to fall with in the scope of the present invention.

1. A wear plate configured in the shape of a polygon, capable of tessellating in a first pattern with other wear plates of the same shape; and, provided with at least one hole for receiving a fastener for securing the wear plate to a structure, the at least one hole positioned to form a second pattern with other holes of the other wear plates when the other wear plates are arranged in the first pattern, where the first pattern is different to the second pattern.

2. The wear plate according to claim 1 wherein the wear plate has six sides and is provided with four holes.

3. The wear plate according to claim 2 wherein the holes are located at corners of an imaginary rectilinear figure configured with two opposite sides parallel to respective adjacent sides of the wear plate and two remaining sides aligned with respective corners of the wear plate closest to the holes.

4. The wear plate according to claim 2 wherein the second pattern comprises a repeating pattern of rectangles of uniform configuration or a repeating pattern of two rectangles of different configuration.

5. A wear plate system comprising:
a set of first wear plates comprising:
a plurality of whole wear plates, each whole wear plate being in accordance with a wear plate of claim 1; and,
one or more part plates wherein each part plate is derived from a whole plate and has at least one side that incorporates at least a portion of a side of a whole plate and at least one of the holes of that whole plate;
the holes in the first wear plates positioned to generate a repeating second pattern when the first wear plates are tessellated in the first pattern.

6. The wear plate system according to claim 5 comprising a set of one or more second plates, the or each second wear plate being of a different shape to, and having maximum dimension in a plane of the second wear plate greater than a maximum dimension in a plane of, a whole wear plate; the or each second wear plate configured to abut along the sides of two or more first plates when tessellated in the first pattern to form a substantially continuous wear plate liner surface, the second wear plates provided with one or more holes through which respective fasteners can pass and engage the second plates; the holes in the first wear plates and the holes in the second wear plates positioned to lie in the repeating second pattern.

7. The wear plate system according to claim 6 wherein each whole plate is in the shape of a regular hexagon and the or each second plate is in the shape of a triangle.

8. A method of constructing a materials handling structure through which abrasive materials pass, the structure having one or more sides to which a plurality of wear plates is to be attached, the method comprising:
forming a plurality of wear plates comprising one or more whole plates and one or more part plates, wherein each whole plate is formed with: uniform shape and dimension and configured to enable the plates to tessellate in a first pattern; and, a plurality of holes through which respective fasteners can pass, and wherein the or each part plates is formed by cutting a whole plate in a manner where each part plate includes at least one side that incorporates a portion of a side of a whole plate and at least one of the holes of a whole plate;
dimensioning the or each side of the structure to have a length and a height sufficient to accommodate at least one of the whole plates;
forming the or each side of the structure with a plurality of holes for receiving fasteners at locations that register with holes in the whole plates and the part plates when the whole plates and part plates are arranged in the first pattern; and
covering the or each side with the whole plates and part plates arranged in the first pattern to form a substantially continuous wear plate lining and fastening the plates to the side by fasteners that pass through holes in the plates and the holes in the side of the structure.

9. The method according to claim 8 comprising arranging the plates so that edges of mutually abutting vertically adjacent whole plates are vertically offset from each other.

10. The method according to claim 8 comprising securing strengthening elements to the structure on a side opposite that covered by the plates, wherein the strengthening elements extend along locations that do not cover the holes in the side of the structure.

11. The method according to claim 8 comprising forming each whole plate to sides of equal length A, and wherein dimensioning the or each side of the structure, comprises dimensioning at least one edge of the or each side to have a length which is an integer multiple of (√0.75)/2 A or 0.5 A

12. A method lining a side of a structure with a plurality of wear plates, the method comprising:
providing a plurality of whole wear plates wherein the whole wear plates are of uniform shape and dimension and configured to enable tessellation in a first pattern, the wear plates dimensioned so that at least one whole plate can fit on the side, the whole plates being provided with a plurality of holes through which respective fasteners can pass to fix the wear plates to the structure, the holes being arranged in a second pattern;
determining an area between an outer edge of the whole plates when tessellated on the side to form a partial wear plate lining and adjacent edges of the side of the structure being covered with wear plates, the area being dimensioned so that a whole wear plate can not fit in any location in the area:
cutting one or more part plates from one or more of the whole plates capable of at least partially covering the area when tessellated with the whole plates, wherein each part plate is cut with at least one side incorporating a portion of the side of the whole plate and at least one of the holes of the whole plate; and
covering the side of the structure with the whole plates and part plates to produce a substantially continuous wear plate lining of whole and part plates tessellated in the first pattern; and,
attaching the plates to the surface with mechanical fasteners.

13. The method according to claim 12 further comprises providing a plurality of triangular plates each having a maximum dimension greater than a maximum dimension of a whole plate and, one or more holes to receive a fastener, wherein the triangular plates are configured to cover one or more regions of the area of the surface not covered by whole plates and/or part plates.

14. The method according to claim 8 comprising configuring the second pattern such that the holes lie on first and second sets of lines, the lines in the first set being orthogonal to the lines in the second set, the first set of lines being uniformly spaced, and mutually adjacent lines in the second set of lines being spaced sequentially a first distance apart then a second different distance apart.

15. A computer system arranged to design a structure subject to wear comprising:
an input device which receives user input;
means of interpreting the input so as to conform with or only allowing input which conforms with the method according to claim 8.
